(19) United States
(12) Patent Application Publication
(10) Pub. No.: US 2024/0332590 A1
(43) Pub. Date: Oct. 3, 2024

(54) STACKING APPARATUS AND ELECTRODE BODY PRODUCTION LINE

(71) Applicant: HONDA MOTOR CO., LTD., Tokyo (JP)

(72) Inventor: Shota Ishikawa, Wako-shi (JP)

(21) Appl. No.: 18/591,101

(22) Filed: Feb. 29, 2024

(30) Foreign Application Priority Data
Mar. 31, 2023 (JP) 2023-059305

(51) Int. Cl. H01M 10/04; H01M 10/0585

(52) U.S. Cl. CPC H01M 10/0404; H01M 10/0585

(57) ABSTRACT

A stacking apparatus which is to be disposed downstream of a conveyer that conveys a plurality of electrode bodies and stacks the electrode bodies, the stacking apparatus comprising a mounting plate disposed obliquely with respect to the electrode bodies conveyed by the conveyer, and on which the electrode bodies are stacked, wherein the mounting plate is inclined with respect to the conveyance direction of the electrode bodies and the direction perpendicular to the conveyance direction of the electrode bodies.

### CROSS-REFERENCE TO RELATED APPLICATION

Priority is claimed on Japanese Patent Application No. 2023-059305, filed Mar. 31, 2023, the content of which is incorporated herein by reference.

### BACKGROUND OF THE INVENTION

### Field of the Invention

The present invention relates to a stacking apparatus and an electrode body production line.

### Description of Related Art

In recent years, research and development has been conducted on secondary batteries that contribute to energy efficiency, in order to ensure that more people have access to affordable, reliable, sustainable, and advanced energy.

Laminate cells and stacked prismatic cells, which are used as secondary batteries, have a structure in which a plurality of electrode bodies are stacked and housed in a laminate film or a cell can. Therefore, the process of manufacturing these battery cells includes the process of stacking a plurality of electrode bodies.

For example, International Patent Application Publication No. 2013/125219 discloses a technique for stacking a positive electrode sheet, a negative electrode sheet, a separator, etc. by the operation of a rotating unit having an arm.

### SUMMARY OF THE INVENTION

However, in the conventional technique described above, the arms grasp and stack the objects one by one, so that it may take time to complete the stacking, and therefore there is room for improvement.

The present invention provides a stacking apparatus and a production line that reduce the time required for stacking a plurality of electrode bodies. This in turn contributes to energy efficiency.

The embodiments of the present invention have the following configurations.

[1] A stacking apparatus which is to be disposed downstream of a conveyer that conveys a plurality of electrode bodies and stacks the electrode bodies, the stacking apparatus comprising:
a mounting plate disposed obliquely with respect to a conveyance direction in which the electrode bodies are conveyed by the conveyer, and on which the electrode bodies are to be stacked;
a first wall section that is erected on the mounting plate and extends along the conveyance direction of the electrode bodies;
a second wall section that is erected on the mounting plate, intersects the first wall section, and is provided on one end side of the first wall section in the conveyance direction of the electrode bodies;
a fall prevention section that is provided on the second wall section or on a wall section other than the second wall section, and prevents the electrode bodies from falling from the mounting plate,
wherein the mounting plate is inclined downward as a distance from the conveyer increases in the conveyance direction of the electrode bodies, and slopes downward toward the first wall section in a direction perpendicular to the conveyance direction of the electrode bodies.

The stacking apparatus of the present invention can implement stacking utilizing the movement of the electrode bodies themselves that are being conveyed, and can thereby shorten the time required to complete the stacking. Further, since the electrode bodies that has been conveyed come into contact with the first wall section and the second wall section, displacement is prevented by the first wall section and the second wall section. Furthermore, the fall prevention section of the mounting plate can prevent the electrode bodies from falling from the mounting plate.

[2] The stacking apparatus according to [1], wherein the mounting plate has an inclination angle of 10° or more and 25° or less with respect to the conveyance direction of the electrode bodies, and an inclination angle of 10° or more and 20° or less with respect to the direction perpendicular to the conveyance direction of the electrode bodies.

The stacking apparatus of the present invention can implement stacking utilizing the movement of the electrode bodies themselves that are being conveyed, and can thereby shorten the time required to complete the stacking. Further, since the electrode bodies that has been conveyed come into contact with the first wall section and the second wall section, displacement is prevented by the first wall section and the second wall section. Furthermore, the fall prevention section of the mounting plate can prevent the electrode bodies from falling from the mounting plate.

[3] The stacking apparatus according to [1] or [2], wherein the second wall section comprises a cushioning member.

According to the stacking apparatus of the present invention, it is possible to suppress the impact when the electrode bodies collide with the second wall section, so that damage to the electrode bodies can be suppressed.

[4] The stacking apparatus according to any one of [1] to [3], wherein the fall prevention section comprises a current collector foil receiving section that receives and accommodates current collector foils belonging to the electrode bodies.

The stacking apparatus of the present invention can prevent the current collector foil from being damaged.

[5] The stacking apparatus according to any one of [1] to [4], wherein each of the electrode bodies comprises a first negative electrode layer, a first solid electrolyte layer, a positive electrode layer, a second solid electrolyte layer, and a second negative electrode layer,
wherein each of the electrode bodies has a current collector that is formed of copper at an end portion of the first negative electrode layer, the positive electrode layer and the second negative electrode layer in a stacking direction thereof.

Since the electrode bodies include a solid electrolyte layer rather than a liquid or gel electrolyte, the stacking apparatus of the present invention can decrease the possibility of the electrode bodies being damaged in collision with the first wall section and the second wall section.

[6] An electrode body production line that conveys and stacks a plurality of electrode bodies, comprising:
a conveyer that conveys the electrode bodies;
a plurality of the stacking apparatuses according to any one of [1] to [5];
wherein the electrode body production line is configured to switch the stacking apparatuses such that, when a predetermined number of the electrode bodies are stacked on one of the stacking apparatuses, the electrode bodies are stacked on another one the lamination apparatuses.

The electrode body production line of the present invention can stack electrode bodies successively, and can thereby shorten the time required to complete the stacking.

The embodiment of the present invention can shorten the time required to stack a plurality of electrode bodies.

### BRIEF DESCRIPTION OF THE DRAWINGS

FIG. 1 is a schematic view showing an electrode body production line according to an embodiment of the present invention.

FIG. 2 is a perspective view showing a stacking apparatus (stocker) according to an embodiment of the present invention.

FIG. 3 is a plan view showing a stacking apparatus (stocker) according to an embodiment of the present invention.

FIG. 4 is a perspective view showing a laminate cell produced with the electrode body production line according to an embodiment of the present invention.

### DETAILED DESCRIPTION OF THE INVENTION

Hereinbelow, the embodiments of the present invention are described in detail, referring to the annexed drawings.

### [Electrode Body Production Line and Stacking Apparatus]

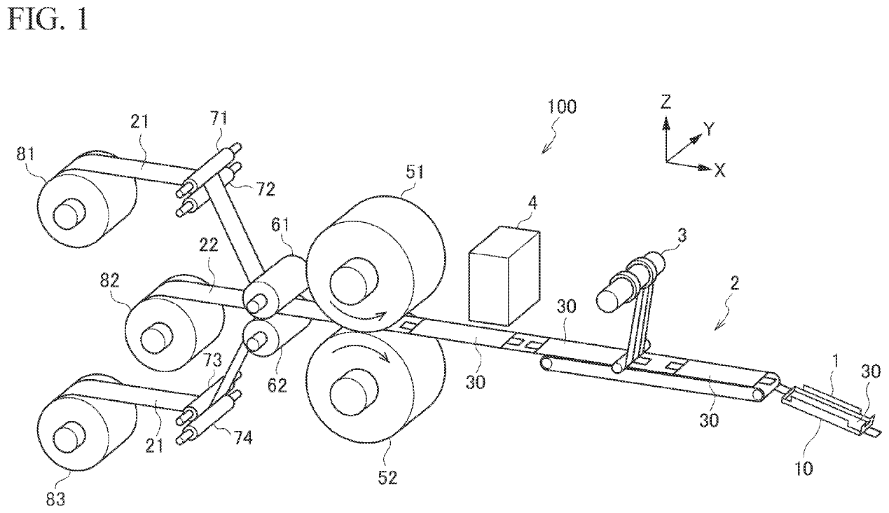

FIG. 1 is a schematic view showing an electrode body production line according to an embodiment of the present invention.

As shown in FIG. 1, the production line 100 of the present embodiment includes a conveyer 2 that conveys a plurality of electrode bodies 30, and a stacking apparatus (stocker) 1 that is disposed downstream of the conveyer 2 and stacks a plurality of electrode bodies 30.

The conveyer 2 is provided with electrode rolls 81 and 83 around which the negative electrode members 21 are wound, and an electrode roll 82 around which the positive electrode member 22 is wound. The positive electrode member 22 includes a current collector foil and a positive electrode active material coated on the current collector foil. The negative electrode member 21 includes a current collector foil and a negative electrode active material coated on the current collector foil. The battery cell in the present embodiment is a solid-state battery, wherein the positive electrode member 22 (positive electrode layer) is interposed between a pair of negative electrode members 21 (negative electrode layers). A solid electrolyte layer is interposed between the positive electrode member (positive electrode layer) and the negative electrode member (negative electrode layer). The production line 100, the solid electrolyte layer may be provided on both sides of the positive electrode member 22, or may be provided on one side of the negative electrode member 21. In the present specification, the structure in which the positive electrode member 22 is interposed between the negative electrode members 21 is referred to as an electrode body 30.

In one preferred embodiment of the present invention, the current collector is formed of copper at its end portion in a stacking direction of the pair of negative electrode member 21 (negative electrode layer) and the positive electrode member 22 (positive electrode layer).

In a later step, the electrode bodies 30 are provided with tab leads that are joined to the current collector foils of the positive and negative electrodes, respectively, and are covered with a laminate film with the tab leads exposed. FIG. 4 is a perspective view showing a laminate cell 40 using the electrode bodies 30 produced on the production line 100.

The conveyance direction of the electrode bodies 30 in the present embodiment coincides with the longitudinal direction of the electrode bodies 30. The electrode member 21 of the negative electrode roll 81 is guided by roll devices 71 and 72, and is laminated on other electrode members by roll devices 61 and 62. The positive electrode roll 82 is guided by the roll devices 61 and 62 and laminated on other electrode members. The electrode member 21 of the negative electrode roll 83 is guided by roll devices 73 and 74, and is laminated on other electrode members by the roll devices 61 and 62.

The three electrode members laminated together by the roll devices 61 and 62 are integrated under pressure from above and below by the roll presses 51 and 52. Next, the laser cutter 4 installed above the conveyance path emits a laser beam to notch the remnant edge sections on the outer periphery of the integrated electrode body 30. For example, when the electrode body 30 is transferred to the conveyer 2, which is a belt conveyer, the notched remnant edge sections are wound up by the remnant material winding device 3.

The conveyer 2 conveys the electrode body 30 at a predetermined speed (for example, 100 m/min). The electrode body 30 that has been conveyed to the end of the conveyer 2 is ejected from the conveyer 2 due to inertia and falls onto the stocker 1. In the stocker 1, the electrode bodies 30 sent from the conveyer 2 are stacked one upon another. The stocker 1 is disposed at a position downstream of the conveyer 2 and close to the conveyer 2 (that is, at a position where the electrode body 30 sent from the conveyer 2 can be received).

Further, the production line 100 of the present embodiment may include a plurality of the stockers 1, and may be configured to switch the stockers 1 such that, when a predetermined number of the electrode bodies 30 are stacked on one of the stockers 1, the electrode bodies 30 are stacked on another one the stockers 1.

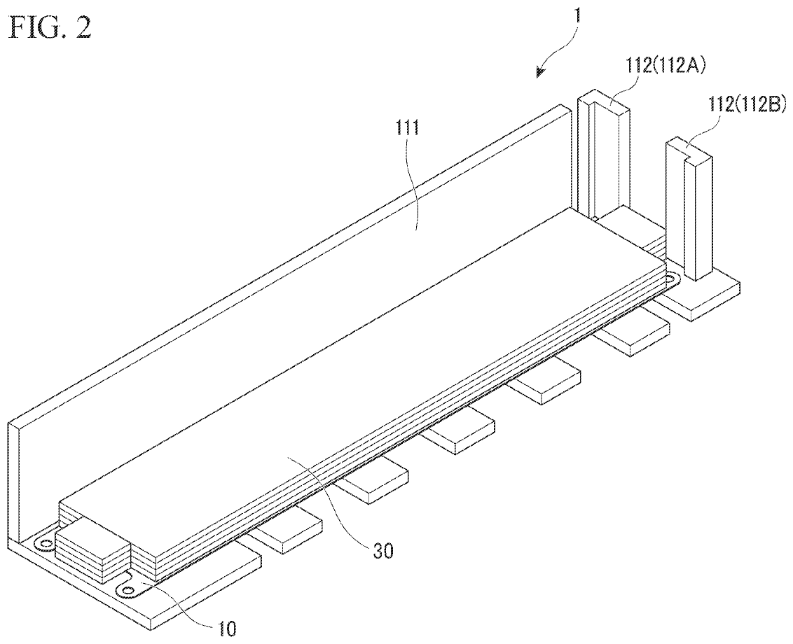

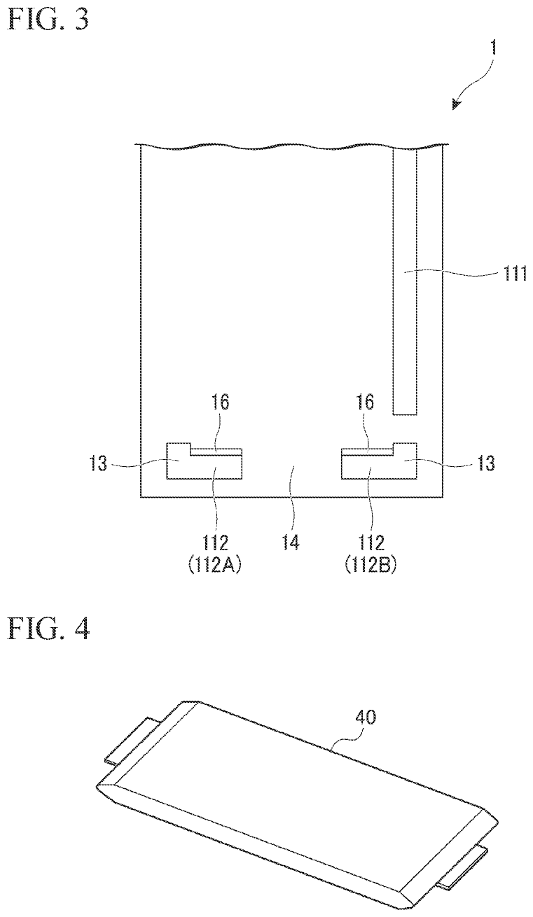

FIG. 2 is a perspective view showing a stacking apparatus (stocker) according to an embodiment of the present invention. FIG. 3 is a plan view showing a stacking apparatus (stocker) according to an embodiment of the present invention. The stocker 1 includes a mounting plate 10 on which a plurality of electrode bodies 30 are to be stacked. The mounting plate 10 has a first wall section 111 and a second wall section 112. The first wall section 111 is erected on the mounting plate 10 along the conveyance direction. The second wall section 112 intersects with the first wall section 111 and is erected on the mounting plate 10 at one end side of the first wall section 111 in the conveyance direction. The second wall section 112 has a pair of wall sections 112A and 112B extending orthogonally to the conveyance direction. The wall sections 112A and 112B are spaced apart from each other and are arranged to face each other across the conveyance path of the electrode bodies 30 on the mounting plate 10. The electrode bodies 30 stacked in alignment on the mounting plate 10 by the first wall section 111 and the second wall section 112 (that is, the electrode bodies 30 are arranged without displacement as viewed in the stacking direction).

The first wall section 111 is a surface facing the conveyer 2 in the Y-axis direction, which is a direction perpendicular to the conveyance direction.

The second wall section 112 is a surface facing the conveyer 2 in the X-axis direction, which is the conveyance direction of the electrode bodies 30, and has a fall prevention section 13 that prevents the electrode bodies 30 from falling from the mounting plate 10. In the second wall section 112, an opening 14 is provided in the fall prevention section 13 at the center in the Y-axis direction. In the Y-axis direction perpendicular to the conveyance direction, the width of the opening 14 is larger than the width of the current collector foil extending from the electrode body 30. Therefore, even when the electrode body 30 reaches the second wall section 112 (that is, the fall prevention section 13), the current collector foil is accommodated in the opening 14, so that the second wall section 112 does not interfere with the current collector foil. In the example shown in FIG. 2, the second wall section 112 functions as the fall prevention section 13, but the fall prevention section is not particularly limited as long as it has a structure that can prevent the electrode body 30 from falling from the downstream end of the stocker 1 in the conveyance direction (X-axis direction).

The mounting plate 10 of the stocker 1 is inclined downward as it goes from the upstream side to the downstream side in the conveyance direction (X-axis direction), that is, as a distance from the conveyer 2 increases. Therefore, the electrode body 30 conveyed to the stocker 1 moves downward toward the second wall section 112, comes into contact with the second wall section 112 (fall prevention portion 13), and stops. Further, the mounting plate 10 of the stocker 1 is inclined downward toward the first wall section 111 in the direction (Y-axis direction) perpendicular to the conveyance direction. Therefore, the electrode body 30 conveyed to the stocker 1 moves downward toward the first wall section 111, comes into contact with the first wall section 111, and stops.

As a result, the electrode bodies 30 that are successively conveyed from the conveyer 2 are stacked in contact with the first wall section 111 and the second wall section 112 (fall prevention section 13), and can be aligned without a mechanism for alignment.

The mounting plate 10 preferably has an inclination angle of 10° or more and 25° or less, more preferably 20° or more and 25° or less with respect to the conveyance direction (X-axis direction) of the electrode body 30. Further, the mounting plate 10 preferably has an inclination angle of 10° or more and 20° or less, more preferably 15° or more and 20° or less with respect to the direction (Y-axis direction) perpendicular to the conveyance direction of the electrode body 30. As long as the inclination angles of the mounting plate 10 with respect to the X-axis direction and the Y-axis direction are within the above ranges, the electrode bodies 30 can be stacked in alignment even without a mechanism for alignment.

The second wall section 112 may include a cushioning member 16 on the surface that contacts the electrode bodies 30. The cushioning member 16 can suppress the impact when the electrode bodies 30 collide with the second wall section 112, so that damage to the electrode bodies 30 can be suppressed.

As described above, the stacking apparatus 1 of the present embodiment can stack the electrode bodies 30 utilizing the movement (e.g., falling) of the electrode bodies 30 themselves, so that the time required to complete the stacking can be shortened.

Further, the process after stacking the electrode bodies 30 includes a process such as lamination. When the electrode bodies 30 are stacked with misalignment, subsequent steps cannot be carried out; therefore, it is important to align the electrode bodies 30 without misalignment. In the stacking apparatus 1 of the present embodiment, the mounting plate 10 is inclined downward from the upstream side to the downstream side in the conveyance direction, and is inclined downward toward the first wall section 111 in the direction perpendicular to the conveyance direction. Therefore, the electrode body 30 conveyed to the stocker 1 moves downward toward the first wall section 111 and the second wall section 112, comes into contact with the first wall section 111 and the second wall section 112, and stops.

Although various embodiments are described above with reference to the drawings, it goes without saying that the present invention is not limited to such examples. It is clear that those skilled in the art can conceive various alterations and modifications within the scope of the claims, which are naturally understood to fall within the technical scope of the present invention. Further, the constituent elements in the above embodiments may be combined in any manner as long as such combinations do not deviate from the essence of the present invention.

### Examples

Hereinbelow, the present invention will be described in more detail with reference to an experimental example which, however, should not be construed as limiting the present invention.

### Experiment Example

Electrode bodies were produced and stacked using an electrode body production line and stacking apparatus shown in FIGS. 1, 2 and 3. For stacking electrode bodies using the stacking apparatus, the mounting plate of the stacking apparatus was inclined with respect to the conveyance direction (X-axis direction) and the direction (Y-axis direction) perpendicular to the conveyance direction. The inclination angles of the mounting plate with respect to the X-axis direction and the Y-axis direction were changed from 0° to 30°.

As a result, when the inclination angle of the mounting plate with respect to the X-axis direction was 10° or more and 25° or less, and the inclination angle of the mounting plate with respect to the Y-axis direction was 10° or more and 20° or less, the electrode bodies could be stacked while suppressing misalignment.

What is claimed is:

1. A stacking apparatus which is to be disposed downstream of a conveyer that conveys a plurality of electrode bodies and stacks the electrode bodies, the stacking apparatus comprising:
a mounting plate disposed obliquely with respect to a conveyance direction in which the electrode bodies are conveyed by the conveyer, and on which the electrode bodies are stacked;
a first wall section that is erected on the mounting plate and extends along the conveyance direction of the electrode bodies;
a second wall section that is erected on the mounting plate, intersects the first wall section, and is provided on one end side of the first wall section in the conveyance direction of the electrode bodies;
a fall prevention section that is provided on the second wall section or on a wall section other than the second wall section, and prevents the electrode bodies from falling from the mounting plate,
wherein the mounting plate is inclined downward as a distance from the conveyer increases in the conveyance direction of the electrode bodies, and inclined downward toward the first wall section in a direction perpendicular to the conveyance direction of the electrode bodies.

2. The stacking apparatus according to claim 1, wherein the mounting plate has an inclination angle of 10° or more and 25° or less with respect to the conveyance direction of the electrode bodies, and an inclination angle of 10° or more and 20° or less with respect to the direction perpendicular to the conveyance direction of the electrode bodies.

3. The stacking apparatus according to claim 1, wherein the second wall section comprises a cushioning member.

4. The stacking apparatus according to claim 1, wherein the fall prevention section comprises a current collector foil receiving section that receives and accommodates current collector foils belonging to the electrode bodies.

5. The stacking apparatus according to claim 1, wherein each of the electrode bodies comprises a first negative electrode layer, a first solid electrolyte layer, a positive electrode layer, a second solid electrolyte layer, and a second negative electrode layer,
wherein each of the electrode bodies has a current collector that is formed of copper at an end portion of the first negative electrode layer, the positive electrode layer and the second negative electrode layer in a stacking direction thereof.

6. An electrode body production line that conveys and stacks a plurality of electrode bodies, comprising:
a conveyer that conveys the electrode bodies;
a plurality of the stacking apparatuses according to claim 1;
wherein the electrode body production line is configured to switch the stacking apparatuses such that, when a predetermined number of the electrode bodies are stacked on one of the stacking apparatuses, the electrode bodies are stacked on another one the lamination apparatuses.
